(19) United States
(12) Patent Application Publication
(10) Pub. No.: US 2024/0179567 A1
(43) Pub. Date: May 30, 2024

(54) DYNAMIC FUNCTIONAL SPLITTING SYSTEMS AND METHODS

(71) Applicant: RAKUTEN MOBILE, INC., Tokyo (JP)

(72) Inventors: Mohammed SOLIMAN, Tokyo (JP); Krishnan VENKATARAGHAVAN, Tokyo (JP)

(73) Assignee: RAKUTEN MOBILE, INC., Tokyo (JP)

(21) Appl. No.: 17/789,917

(22) PCT Filed: May 31, 2022
(86) PCT No.: PCT/US2022/031520

§ 371 Date: Dec. 7, 2023

(51) Int. Cl. H04W 28/08; H04B 17/391; H04W 28/12

(52) U.S. Cl. CPC H04W 28/0933; H04W 28/0958; H04W 28/12; H04B 17/3913

(57) ABSTRACT

A method for determining an optimal functional split for a radio access network (RAN), includes: obtaining network data relating to performance of RAN elements configured with a current functional split; analyzing, by a machine learning model, the obtained network data to determine an optimum functional split, from among a predetermined plurality of functional splits, for optimizing network performance under current network conditions; and outputting the determined optimum functional split for configuring the RAN elements.

### 1. FIELD

Apparatuses and methods consistent with example embodiments of the present disclosure relate to dynamic functional splitting in radio access networks and, more particularly, to dynamically determining a functional split for a radio access network (RAN) according to changes in network conditions.

### 2. DESCRIPTION OF RELATED ART

Related art radio access networks (RANs), such as Open RAN (O-RAN) architectures, disaggregate the baseband unit (BBU) or base station into three logical nodes: radio unit (RU), distributed unit (DU), and centralized unit (CU). As a result, baseband processing is distributed across these three nodes, with each node capable of hosting different functions of the RAN protocol stack. Table 1 below summarizes functionalities for each layer of the 5G NR RAN protocol stack:

TABLE 1

| Layer | Functionality |
|---|---|
| PHY | (De)Modulation - carrier sensing - (De)coding - power control |
| MAC | Dynamic Scheduling - HARQ - logical channel prioritization |
| RLC | ARQ - concatenation - segmentation |
| RRC | Paging, establishment and maintenance of Radio Bearer |
| PDCP | Header (de)compression - Maintenance SNs - (De)Ciphering - |
| | Handling Integrity |

FIG. 1 illustrates a mapping of layers/sublayers of the 5G NR RAN stack to the RU, DU, and CU. While FIG. 1 illustrates one particular example, this is not the only possible mapping. Rather, when rolling out a network, a mobile network operator (MNO) can select how to split or map the layers of the protocol stack to the logical nodes, as shown in FIG. 2.

FIG. 2 illustrates the eight different options or functional splits for distributing the functionality of the RAN protocol stack across the RAN, e.g., between the RU and the DU/CU, in the related art. Referring to FIG. 2, Split (or Option) 8 maps only the radio frequency (RF) functionality to the RU, while Split 1 places all the baseband processing within the RU. Each split option has advantages and disadvantages relative to the others and offers a different trade-off between centralization benefits (i.e., the benefits of centralizing baseband functionality in the CU and DU) and RAN network requirements.

In further detail, higher functional splits (e.g., Split 8) maximize the benefits of centralized baseband processing, including: reduction in deployment effort and RU cost; upgrading done primarily at the CU thereby requiring fewer site visits; increased resource multiplexing gain; better base station coordination to reduce inter-cell interference; increased cell densification to achieve higher data rates; and enablement of load-balancing and sharing of processing capability across the RUs. However, by centralizing the functionality of the RAN stack, Split option 8 places the highest demands on the fronthaul network, with high bandwidth or bit rates, strict latency requirements, and extra energy consumption.

Conversely, the lower functional splits (e.g., Split 1) place more baseband processing within the RU, which thereby results in a larger and more complex RU that consumes more power. The benefit of Split 1 is the looser demands on the fronthaul, as the entire protocol resides in the RU.

Ultimately, the different split levels offer different tradeoffs between the demands on the fronthaul link and the benefits from centralization. The ideal split option therefore generally depends on the deployment scenario and intended network performance (e.g., high speed, low latency, etc.), with no one-size-fits-all split option. That is, different options suit different applications or deployment scenarios.

In the related art, the functional split for a mobile network is generally selected when the mobile network is deployed, and is static. As a result, the selected split option may not be ideal at all times in a given network, particularly as network infrastructures (new cells, downed cells, etc.) and configurations are continuously changing, as well as seasonality of the traffic load on different network parts. Thus, the static functional split in the related art does not optimize a network due to the requirement variabilities (e.g., dynamic load changes, numbers of connected devices, etc.). Since network traffic load, configurations, and/or infrastructure are frequently changing, optimal network performance cannot consistently be achieved by using only one splitting option.

### SUMMARY

According to embodiments, systems and methods are provided for dynamically determining a functional split for a radio access network (RAN) according to current network performance. As a result, an optimal functional split can be determined based on relevant network parameters and a network configuration can be adapted to changing network conditions to thereby consistently optimize network performance.

According to embodiments, a method, performed by at least one processor of a computing device, for determining an optimal functional split for a radio access network (RAN), includes: obtaining network data relating to performance of RAN elements configured with a current functional split; analyzing, by a machine learning model, the obtained network data to determine an optimum functional split, from among a predetermined plurality of functional splits, for optimizing network performance under current network conditions; and outputting the determined optimum functional split for configuring the RAN elements.

The analyzing may include analyzing the obtained network data and determining the optimum functional split by using a reinforcement learning machine learning (ML) model.

The analyzing may include: determining a negative or positive feedback value based on analysis of optimality of current network performance; and updating the ML model and determining the optimum functional split based on the determined feedback value.

The optimality of the current network performance may correspond to at least one of accommodation of current traffic load, satisfaction of latency requirements, and satisfaction of bitrate requirements.

The obtaining the network data may include obtaining the network data from a radio unit, a centralized unit, and a distributed unit of the RAN.

The obtaining, the analyzing, and the outputting may be repeatedly performed.

The network data may include at least one of fronthaul latency, end-to-end latency, end-to-end user downlink throughput, end-to-end user uplink throughput, end-to-end cell downlink throughput, end-to-end cell uplink throughput, delay, and jitter.

According to embodiments, an apparatus for determining an optimal functional split for a radio access network (RAN), includes: a memory storing instructions; and at least one processor configured to execute the instructions to: obtain network data relating to performance of RAN elements configured with a current functional split, analyze, by a machine learning model, the obtained network data to determine an optimum functional split, from among a predetermined plurality of functional splits, for optimizing network performance under current network conditions, and output the determined optimum functional split for configuring the RAN elements.

The at least one processor may be configured to execute the instructions to analyze the obtained network data and determine the optimum functional split by using a reinforcement learning machine learning (ML) model.

The at least one processor may be configured to execute the instructions to: determine a negative or positive feedback value based on analysis of optimality of current network performance; and update the ML model and determine the optimum functional split based on the determined feedback value.

The optimality of the current network performance may correspond to at least one of accommodation of current traffic load, satisfaction of latency requirements, and satisfaction of bitrate requirements.

The obtained network data may be obtained from a radio unit, a centralized unit, and a distributed unit of the RAN.

The at least one processor may be configured to execute the instructions to repeatedly perform the obtaining, the analyzing, and the outputting.

The network data may include at least one of fronthaul latency, end-to-end latency, end-to-end user downlink throughput, end-to-end user uplink throughput, end-to-end cell downlink throughput, end-to-end cell uplink throughput, delay, and jitter.

According to embodiments, a non-transitory computer-readable recording medium has recorded thereon instructions executable by at least one processor to cause the at least one processor to perform a method for determining an optimal functional split for a radio access network (RAN), the method including: obtaining network data relating to performance of RAN elements configured with a current functional split; analyzing, by a machine learning model, the obtained network data to determine an optimum functional split, from among a predetermined plurality of functional splits, for optimizing network performance under current network conditions; and outputting the determined optimum functional split for configuring the RAN elements.

The analyzing may include analyzing the obtained network data and determining the optimum functional split by using a reinforcement learning machine learning (ML) model.

The analyzing may include: determining a negative or positive feedback value based on analysis of optimality of current network performance; and updating the ML model and determining the optimum functional split based on the determined feedback value.

The obtaining the network data may include obtaining the network data from a radio unit, a centralized unit, and a distributed unit of the RAN.

The obtaining, the analyzing, and the outputting may be repeatedly performed.

The network data may include at least one of fronthaul latency, end-to-end latency, end-to-end user downlink throughput, end-to-end user uplink throughput, end-to-end cell downlink throughput, end-to-end cell uplink throughput, delay, and jitter.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a mapping of layers/sublayers of the 5G NR radio access network (RAN) protocol stack to the radio unit (RU), distributed unit (DU), and centralized unit (CU);

FIG. 2 illustrates the eight different options or functional splits for distributing the functionality of the RAN protocol stack across the RAN network in the related art;

FIG. 3 illustrates a block diagram of a system 300 for dynamically determining a functional split for a radio access network (RAN), according to one or more embodiments;

FIG. 4 is a flow diagram of a reinforcement learning model according to an example embodiment;

FIG. 5 illustrates an optimum split determiner according to an example embodiment;

FIG. 6 is a flowchart of a method for dynamically determining a functional split for a RAN, according to one or more embodiments;

FIG. 7 illustrates a method of determining an optimum functional split according to an embodiment;

FIG. 8 is a diagram of an example environment in which systems and/or methods, described herein, may be implemented; and

FIG. 9 is a diagram of example components of a device according to an embodiment.

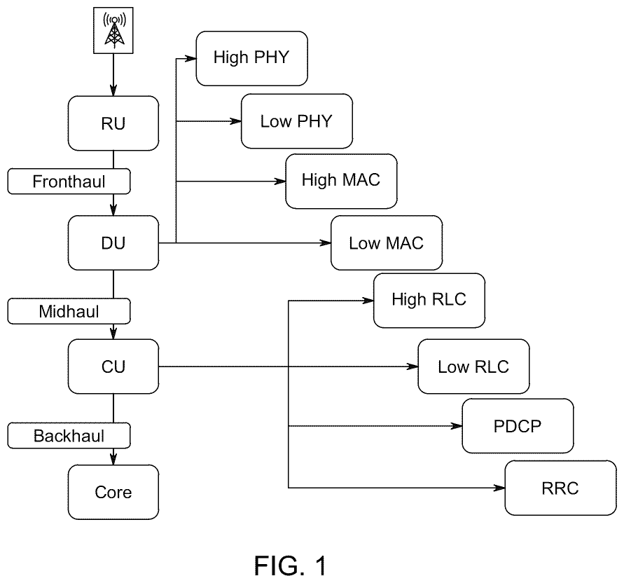

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system that dynamically determine a functional split for a radio access network (RAN) according to current network performance. As a result, an optimal functional split can be determined based on relevant network parameters and the network configuration can be adapted to changing network conditions to thereby accommodate a network system that has varying traffic loads, numbers of devices, etc.

Further, example embodiments of the present disclosure utilize a machine learning (ML) model to periodically determine an optimal functional split for a network based on current network conditions and performance indicators. As a result, a suitable functional split for a network with varying conditions can be easily and conveniently determined for implementation and network optimization.

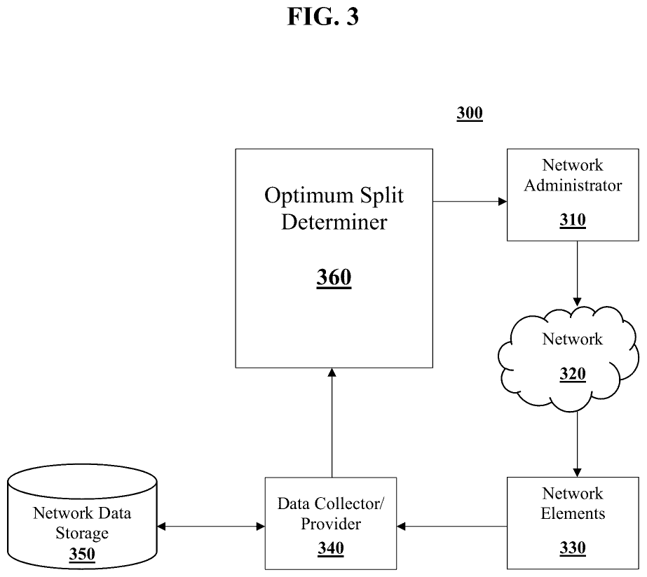

FIG. 3 illustrates a block diagram of a system 300 for dynamically determining a functional split for a radio access network (RAN), according to one or more embodiments. Referring to FIG. 3, the system includes network elements 330, a network 310 via which a network administrator 310 configures the network elements 330 (e.g., via a terminal device), a data collector/provider 340, a network data storage 350, and an optimum split determiner 360.

The network elements 330 are RAN elements that host different functions of the RAN protocol stack (e.g., as shown in Table 1 above) according to an implemented functional split configured for the RAN. The network elements 330 include a radio unit (RU), a distributed unit (DU), and/or a centralized unit (CU).

The data collector/provider 340 is configured to collect various network data (e.g., network parameter or performance data) from one or more of the network elements 330 (e.g., one or all of the RU, CU, and DU) and store the same in the network data storage 350. For example, the data collector/provider 340 may be configured to continuously collect the network data, periodically collect the network data (e.g., once per day, once per hour, etc.), and/or collect the network data in response to an event (e.g., a user input, a triggering event, etc.). Further, the data collector/provider 340 is configured to provide the network data to the optimum split determiner 360. In this regard, the data collector/provider 340 may directly provide the network data collected from the network elements 330 and/or may obtain network data stored in the network data storage 350.

The network data storage 350 is configured to store network data obtained from the network elements 330. The network data may be obtained via the data collector/provider 340, from the network elements 330 directly, and/or via another device. The network data may include at least one of fronthaul latency, end-to-end latency, end-to-end user downlink throughput, end-to-end user uplink throughput, end-to-end cell downlink throughput, end-to-end cell uplink throughput, delay, jitter, etc. Further, it is understood that the network data can include any key performance indicator (KPI) data of the network.

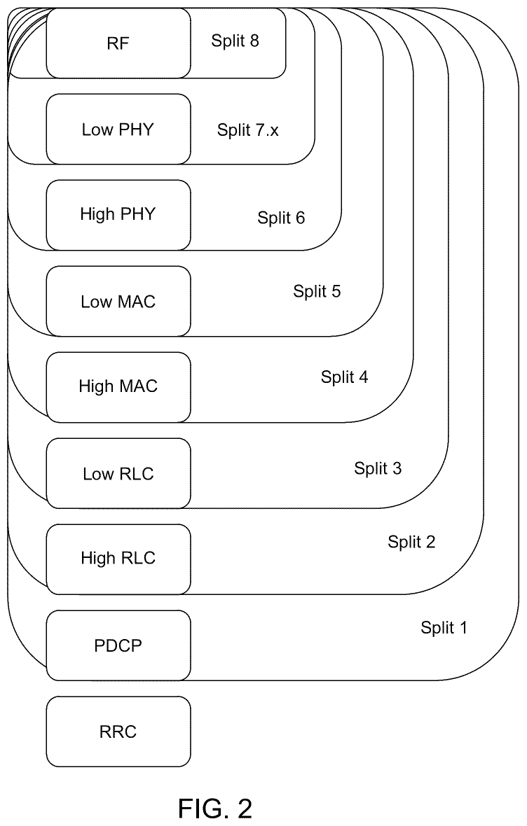

The optimum split determiner 360 is configured to analyze the network data provided by the data collector/provider 340, and determine an optimum split option from among a plurality of predetermined split options (e.g., functional split options 8, 7.x, 6, 5, 4, 3, 2, 1 shown in FIG. 2) based on the analyzing. To this end, the optimum split determiner may include at least one neural network or machine learning (ML) model. The machine learning model may be trained to output a recommended or optimum functional split option based on input network data.

According to an example embodiment, the optimum split determiner may include at least one reinforcement learning ML model that receives the network data, analyzes the network data to determine the optimality of the current network performance, and determines a recommended split option to optimize the network performance based on the determined optimality and historical input data.

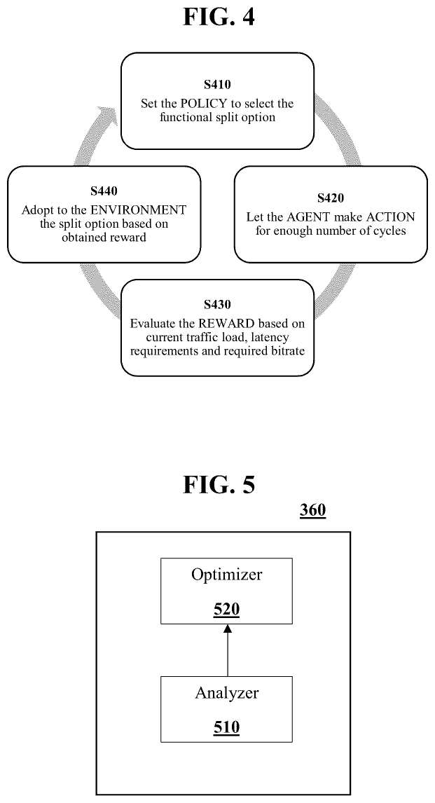

FIG. 4 is a flow diagram of a reinforcement learning model according to an example embodiment. In general, reinforcement learning is a type of machine learning that builds an optimal model by using feedback (rewards or punishments) from historical actions and experiences (e.g., its own historical actions and experiences and/or that of other models). The goal of reinforcement learning is to find a suitable action model that maximizes the total cumulative reward of an agent that implements actions on an environment. As can be seen in FIG. 4, the reinforcement learning model implements an action-reward feedback loop to optimize a policy or action model.

Referring to FIG. 4, at S410, a policy is set to select a functional split option. Here, the policy plays a strategic role to select the best action for an agent to maximize an obtained reward based on the current state (i.e., functional split option) implemented by the agent. The policy changes or recommends the splitting option to be used in a next phase, iteration, or cycle. To this end, the policy is a neural network that is fed with state information to output one or more doable actions for the agent. The agent is responsible for performing the action(s) and then monitoring effect on the environment. In the present embodiment, the agent is the network administrator that is responsible for implementing the recommended split option.

At S420, the agent performs the one or more actions on the environment, i.e., implements the functional split option on the RAN or a part of the RAN. The action is performed or implemented for a predetermined period of time (or one or more cycles), for which network data is collected.

At S430, the reinforcement learning model analyzes the collected network data to calculate or evaluate a reward, i.e., feedback from the environment. For example, the reward may be evaluated based on accommodation of the current traffic load and satisfaction of latency and bitrate requirements.

At S440, the reinforcement learning model adopts a split option for the environment based on the obtained reward (positive or negative feedback value).

It is understood that the ML model is not limited to a reinforcement learning ML model in one or more other embodiments, and other types of ML models may be used to determine the optimum or recommended split option based on input network data.

Referring back to FIG. 3, the optimum split determiner 360 may be configured to determine the optimum split option periodically or based on a trigger event, e.g., one or more of the network data crossing (above or below) a predetermined threshold value, a network value, a KPI value crossing a predetermined threshold value, the determined optimality of the current network performance being equal to a predetermined value or being less than a predetermined value, etc.

Further, the optimum split determiner 360 may be configured to receive the network data from the data collector/provider 340 via a push or a pull method. That is, the network data may be pushed to or pulled (or requested) by the optimum split determiner 360 periodically, continuously, or in response to a particular event (e.g., user request, triggering event such as a network failure, etc.).

A network administrator 310 can thereafter obtain or receive the recommended split option output by the optimum split determiner 360 and configure the network elements 330 via the network 320 accordingly (i.e., implement the recommended split option on the RAN).

FIG. 5 illustrates an optimum split determiner 360 according to an example embodiment. By way of example, the optimum split determiner 360 may be a reinforcement learning model. Referring to FIG. 5, the optimum split determiner 360 includes an analyzer 510 and an optimizer 520.

The analyzer 510 is configured to analyze input network data and decide on an optimality of current network performance. As set forth above, the network is configured (e.g., by a network administrator) with a current functional split option. Network data (e.g., KPI data) is collected to assess performance of the network configured with the current functional split option. The analyzer 510 analyzes that network data to determine a positive or negative feedback value reflecting the optimality of current network data, e.g., at least one of accommodation of the current traffic load, satisfaction of latency and/or bitrate requirements, etc.

The optimizer 520 is configured to receive the determined optimality (feedback value or reward), and analyze the feedback and historical input data (e.g., the network data collected during current iteration of configured split option) to determine a recommended functional split option for optimizing network performance based on, for example, the network infrastructure, latency, and configuration and seasonality of traffic load on different network parts. The optimizer 520 outputs or provides the recommended split option with a network administrator to implement the split on the network.

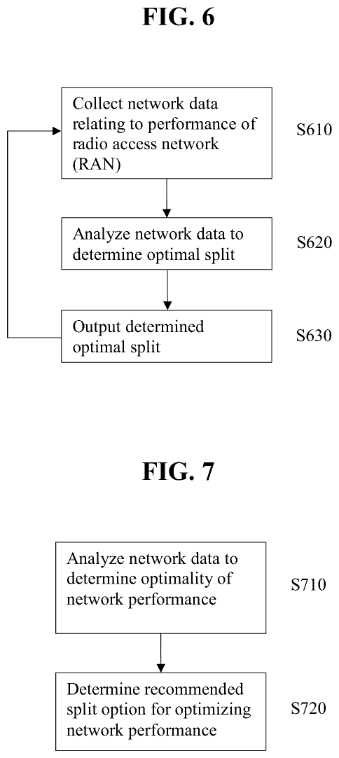

FIG. 6 is a flowchart of a method for dynamically determining a functional split for a RAN, according to one or more embodiments. The method of FIG. 6 may be implemented by one or more devices corresponding to the data collector/provider 340 and optimum split determiner 360 illustrated in FIG. 3.

Referring to FIG. 6, at S610, network data relating to performance of a radio access network configured with a current functional split option is collected. The network data may be collected from one or more network elements 330 and/or from one or more other data sources (e.g., network data storage 350). For example, the network data may be data obtained from a RAN (a RU, a CU, and/or a DU), a core network, a transport network, and/or any suitable network elements. The network data may include at least one of KPIs of the network. For example, the network data may include at least one of fronthaul latency, end-to-end latency, end-to-end user downlink throughput, end-to-end user uplink throughput, end-to-end cell downlink throughput, end-to-end cell uplink throughput, delay, jitter, etc.

At S620, the network data is analyzed to determine an optimum functional split, from among a predetermined plurality of split options (e.g., functional split options 8, 7.x, 6, 5, 4, 3, 2, 1 shown in FIG. 2), for optimizing performance of the network. A detailed description of analyzing and determining an optimum functional split is provided below with reference to FIG. 7.

FIG. 7 illustrates a method of determining an optimum functional split according to an embodiment. Referring to FIG. 7, at S710, the network data is analyzed to determine an optimality of current network performance. For example, the optimality may be a positive or negative feedback value reflecting network performance, e.g., at least one of accommodation of the current traffic load, satisfaction of latency and/or bitrate requirements, etc.

At S720, a recommended split option for optimizing network performance is determined based on the determined optimality and historical input data (e.g., network data collected after previously taken action/previously configured functional split). The historical input data may be used by a machine learning model to judge the effect of the previously taken action, to determine whether modification of the split is required, and if so, to determine which split will optimize the performance.

Referring back to FIG. 6, at S630, the determined functional split is output as a recommendation or a policy for configuring the network. For example, the determined functional split is output to an agent (e.g., computing device or network administrator) for implementing the functional split on the network, i.e., configuring the network elements 330 accordingly. In this regard, if the determined functional split is the same as a current functional split, the determined functional split may not be output or provided to the agent as no change is needed to optimize the network performance.

The method then returns to S610 and is repeated. That is, the method may be implemented as a continuous feedback loop for dynamically determining an optimal functional split for the RAN or a portion of the RAN. In this regard, operation S610 may be performed again after a predetermined period of time or predetermined number of cycles after operation S620 or operation S630 is performed, or after a change to the functional split is implemented on the network. Further, it is understood that the method may be re-performed in response to a triggering event or request of a user.

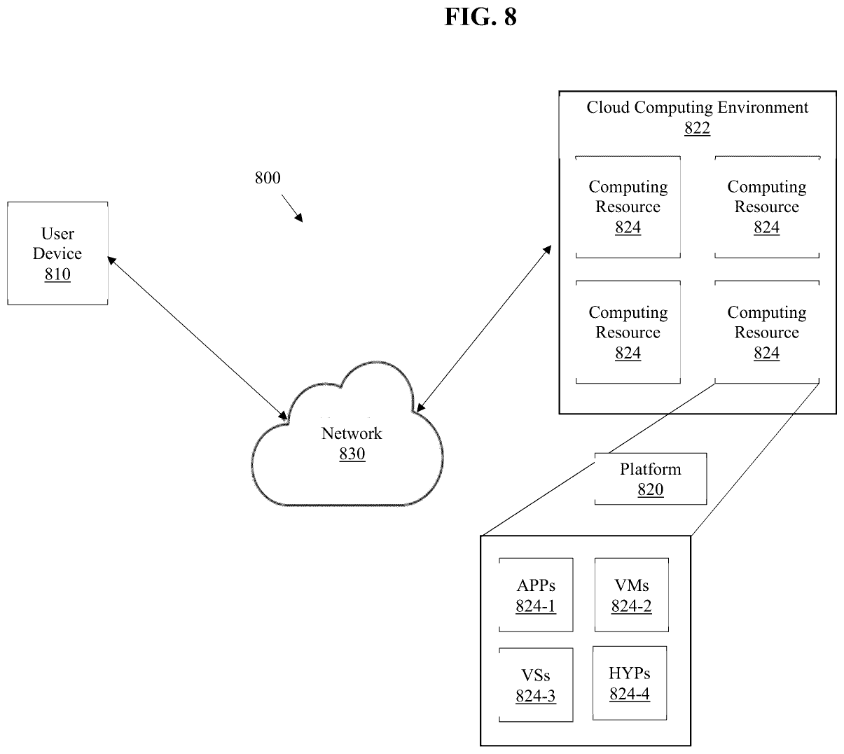

FIG. 8 is a diagram of an example environment 800 in which systems and/or methods, described herein, may be implemented. As shown in FIG. 8, environment 800 may include a user device 810, a platform 820, and a network 830. Devices of environment 800 may interconnect via wired connections, wireless connections, or a combination of wired and wireless connections. In embodiments, any of the functions and operations described with reference to FIGS. 3 through 7 above may be performed by any combination of elements illustrated in FIG. 8.

User device 810 includes one or more devices capable of receiving, generating, storing, processing, and/or providing information associated with platform 820. For example, user device 810 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), a SIM-based device, or a similar device. In some implementations, user device 810 may receive information from and/or transmit information to platform 820.

Platform 820 includes one or more devices capable of receiving, generating, storing, processing, and/or providing information. In some implementations, platform 820 may include a cloud server or a group of cloud servers. In some implementations, platform 820 may be designed to be modular such that certain software components may be swapped in or out depending on a particular need. As such, platform 820 may be easily and/or quickly reconfigured for different uses.

In some implementations, as shown, platform 820 may be hosted in cloud computing environment 822. Notably, while implementations described herein describe platform 820 as being hosted in cloud computing environment 822, in some implementations, platform 820 may not be cloud-based (i.e., may be implemented outside of a cloud computing environment) or may be partially cloud-based.

Cloud computing environment 822 includes an environment that hosts platform 820. Cloud computing environment 822 may provide computation, software, data access, storage, etc. services that do not require end-user (e.g., user device 810) knowledge of a physical location and configuration of system(s) and/or device(s) that hosts platform 820. As shown, cloud computing environment 822 may include a group of computing resources 824 (referred to collectively as “computing resources 824” and individually as “computing resource 824”).

Computing resource 824 includes one or more personal computers, a cluster of computing devices, workstation computers, server devices, or other types of computation and/or communication devices. In some implementations, computing resource 824 may host platform 820. The cloud resources may include compute instances executing in computing resource 824, storage devices provided in computing resource 824, data transfer devices provided by computing resource 824, etc. In some implementations, computing resource 824 may communicate with other computing resources 824 via wired connections, wireless connections, or a combination of wired and wireless connections.

As further shown in FIG. 8, computing resource 824 includes a group of cloud resources, such as one or more applications (“APPs”) 824-1, one or more virtual machines (“VMs”) 824-2, virtualized storage (“VSs”) 824-3, one or more hypervisors (“HYPs”) 824-4, or the like.

Application 824-1 includes one or more software applications that may be provided to or accessed by user device 810. Application 824-1 may eliminate a need to install and execute the software applications on user device 810. For example, application 824-1 may include software associated with platform 820 and/or any other software capable of being provided via cloud computing environment 822. In some implementations, one application 824-1 may send/receive information to/from one or more other applications 824-1, via virtual machine 824-2.

Virtual machine 824-2 includes a software implementation of a machine (e.g., a computer) that executes programs like a physical machine. Virtual machine 824-2 may be either a system virtual machine or a process virtual machine, depending upon use and degree of correspondence to any real machine by virtual machine 824-2. A system virtual machine may provide a complete system platform that supports execution of a complete operating system (“OS”). A process virtual machine may execute a single program, and may support a single process. In some implementations, virtual machine 824-2 may execute on behalf of a user (e.g., user device 810), and may manage infrastructure of cloud computing environment 822, such as data management, synchronization, or long-duration data transfers.

Virtualized storage 824-3 includes one or more storage systems and/or one or more devices that use virtualization techniques within the storage systems or devices of computing resource 824. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 824-4 may provide hardware virtualization techniques that allow multiple operating systems (e.g., “guest operating systems”) to execute concurrently on a host computer, such as computing resource 824. Hypervisor 824-4 may present a virtual operating platform to the guest operating systems, and may manage the execution of the guest operating systems. Multiple instances of a variety of operating systems may share virtualized hardware resources.

Network 830 includes one or more wired and/or wireless networks. For example, network 830 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 8 are provided as an example. In practice, there may be additional devices and/or networks, fewer devices and/or networks, different devices and/or networks, or differently arranged devices and/or networks than those shown in FIG. 8. Furthermore, two or more devices shown in FIG. 8 may be implemented within a single device, or a single device shown in FIG. 8 may be implemented as multiple, distributed devices. Additionally, or alternatively, a set of devices (e.g., one or more devices) of environment 800 may perform one or more functions described as being performed by another set of devices of environment 800.

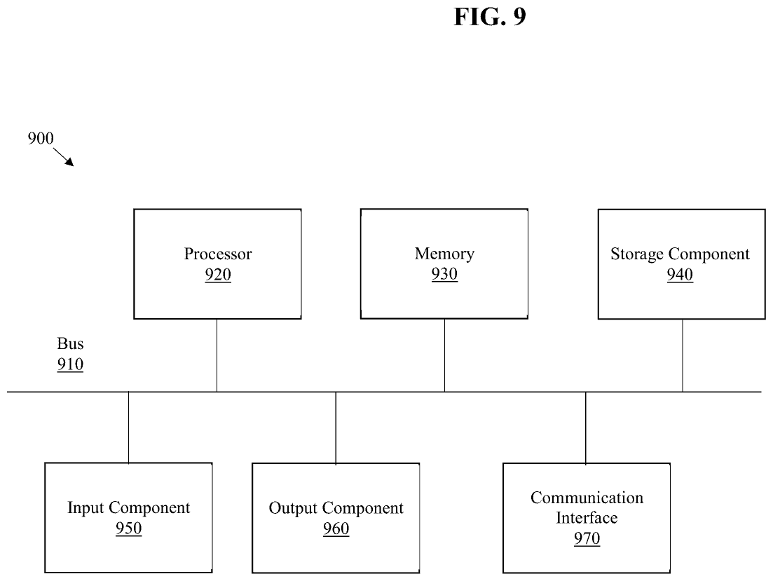

FIG. 9 is a diagram of example components of a device 900. Device 900 may correspond to user device 810 and/or platform 820. As shown in FIG. 9, device 900 may include a bus 910, a processor 920, a memory 930, a storage component 940, an input component 950, an output component 960, and a communication interface 970.

Bus 910 includes a component that permits communication among the components of device 900. Processor 920 may be implemented in hardware, firmware, or a combination of hardware and software. Processor 920 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 920 includes one or more processors capable of being programmed to perform a function. Memory 930 includes a random access memory (RAM), a read only memory (ROM), and/or another type of dynamic or static storage device (e.g., a flash memory, a magnetic memory, and/or an optical memory) that stores information and/or instructions for use by processor 920.

Storage component 940 stores information and/or software related to the operation and use of device 900. For example, storage component 940 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 950 includes a component that permits device 900 to receive information, such as via user input (e.g., a touch screen display, a keyboard, a keypad, a mouse, a button, a switch, and/or a microphone). Additionally, or alternatively, input component 950 may include a sensor for sensing information (e.g., a global positioning system (GPS) component, an accelerometer, a gyroscope, and/or an actuator). Output component 960 includes a component that provides output information from device 900 (e.g., a display, a speaker, and/or one or more light-emitting diodes (LEDs)).

Communication interface 970 includes a transceiver-like component (e.g., a transceiver and/or a separate receiver and transmitter) that enables device 900 to communicate with other devices, such as via a wired connection, a wireless connection, or a combination of wired and wireless connections. Communication interface 970 may permit device 900 to receive information from another device and/or provide information to another device. For example, communication interface 970 may include an Ethernet interface, an optical interface, a coaxial interface, an infrared interface, a radio frequency (RF) interface, a universal serial bus (USB) interface, a Wi-Fi interface, a cellular network interface, or the like.

Device 900 may perform one or more processes described herein. Device 900 may perform these processes in response to processor 920 executing software instructions stored by a non-transitory computer-readable medium, such as memory 930 and/or storage component 940. A computer-readable medium is defined herein as a non-transitory memory device. A memory device includes memory space within a single physical storage device or memory space spread across multiple physical storage devices.

Software instructions may be read into memory 930 and/or storage component 940 from another computer-readable medium or from another device via communication interface 970. When executed, software instructions stored in memory 930 and/or storage component 940 may cause processor 920 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 9 are provided as an example. In practice, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

In embodiments, any one of the operations or processes of FIGS. 3 through 7 may be implemented by or using any one of the elements illustrated in FIGS. 8 and 9.

As set forth above, methods and systems according to at least some example embodiments are capable of dynamically determining a functional split for a RAN to optimize network performance while accommodating changes to network conditions. As a result, a suitable functional split for a network with varying conditions can be easily and conveniently determined for implementation and network optimization.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method for determining an optimal functional split for a radio access network (RAN), the method comprising:
obtaining network data relating to performance of RAN elements configured with a current functional split;
analyzing, by a machine learning model, the obtained network data to determine an optimum functional split, from among a predetermined plurality of functional splits, for optimizing network performance under current network conditions; and
outputting the determined optimum functional split for configuring the RAN elements.

2. The method as claimed in claim 1, wherein the analyzing comprises analyzing the obtained network data and determining the optimum functional split by using a reinforcement learning machine learning (ML) model.

3. The method as claimed in claim 1, wherein the analyzing comprises:
determining a negative or positive feedback value based on analysis of optimality of current network performance; and
updating the ML model and determining the optimum functional split based on the determined feedback value.

4. The method as claimed in claim 3, wherein the optimality of the current network performance corresponds to at least one of accommodation of current traffic load, satisfaction of latency requirements, and satisfaction of bitrate requirements.

5. The method as claimed in claim 1, wherein the obtaining the network data comprises obtaining the network data from at least one of a radio unit of the RAN, a centralized unit of the RAN, a distributed unit of the RAN, a transport network element, and a core network element.

6. The method as claimed in claim 1, wherein the obtaining, the analyzing, and the outputting are repeatedly performed.

7. The method as claimed in claim 1, wherein the network data comprises at least one of fronthaul latency, end-to-end latency, end-to-end user downlink throughput, end-to-end user uplink throughput, end-to-end cell downlink throughput, end-to-end cell uplink throughput, delay, and jitter.

8. An apparatus for determining an optimal functional split for a radio access network (RAN), the apparatus comprising:
a memory storing instructions; and
at least one processor configured to execute the instructions to:
obtain network data relating to performance of RAN elements configured with a current functional split,
analyze, by a machine learning model, the obtained network data to determine an optimum functional split, from among a predetermined plurality of functional splits, for optimizing network performance under current network conditions, and
output the determined optimum functional split for configuring the RAN elements.

9. The apparatus as claimed in claim 8, wherein the at least one processor is configured to execute the instructions to analyze the obtained network data and determine the optimum functional split by using a reinforcement learning machine learning (ML) model.

10. The apparatus as claimed in claim 8, wherein the at least one processor is configured to execute the instructions to:
determine a negative or positive feedback value based on analysis of optimality of current network performance; and
update the ML model and determine the optimum functional split based on the determined feedback value.

11. The apparatus as claimed in claim 10, wherein the optimality of the current network performance corresponds to at least one of accommodation of current traffic load, satisfaction of latency requirements, and satisfaction of bitrate requirements.

12. The apparatus as claimed in claim 8, wherein the obtained network data is obtained from at least one of a radio unit of the RAN, a centralized unit of the RAN, a distributed unit of the RAN, a transport network element, and a core network element.

13. The apparatus as claimed in claim 8, wherein the at least one processor is configured to execute the instructions to repeatedly perform the obtaining, the analyzing, and the outputting.

14. The apparatus as claimed in claim 8, wherein the network data comprises at least one of fronthaul latency, end-to-end latency, end-to-end user downlink throughput, end-to-end user uplink throughput, end-to-end cell downlink throughput, end-to-end cell uplink throughput, delay, and jitter.

15. A non-transitory computer-readable recording medium having recorded thereon instructions executable by at least one processor to cause the at least one processor to perform a method for determining an optimal functional split for a radio access network (RAN), the method comprising:
obtaining network data relating to performance of RAN elements configured with a current functional split;
analyzing, by a machine learning model, the obtained network data to determine an optimum functional split, from among a predetermined plurality of functional splits, for optimizing network performance under current network conditions; and
outputting the determined optimum functional split for configuring the RAN elements.

16. The non-transitory computer-readable recording medium as claimed in claim 15, wherein the analyzing comprises analyzing the obtained network data and determining the optimum functional split by using a reinforcement learning machine learning (ML) model.

17. The non-transitory computer-readable recording medium as claimed in claim 15, wherein the analyzing comprises:
determining a negative or positive feedback value based on analysis of optimality of current network performance; and
updating the ML model and determining the optimum functional split based on the determined feedback value.

18. The non-transitory computer-readable recording medium as claimed in claim 15, wherein the obtaining the network data comprises obtaining the network data from at least one of a radio unit of the RAN, a centralized unit of the RAN, a distributed unit of the RAN, a transport network element, and a core network element.

19. The non-transitory computer-readable recording medium as claimed in claim 15, wherein the obtaining, the analyzing, and the outputting are repeatedly performed.

20. The non-transitory computer-readable recording medium as claimed in claim 15, wherein the network data comprises at least one of fronthaul latency, end-to-end latency, end-to-end user downlink throughput, end-to-end user uplink throughput, end-to-end cell downlink throughput, end-to-end cell uplink throughput, delay, and jitter.
